(19) United States
(12) Patent Application Publication
(10) Pub. No.: US 2022/0213381 A1
(43) Pub. Date: Jul. 7, 2022

(54) NANOCRYSTAL EMISSIVE MATERIALS, LIGHT EMITTING ELEMENT, AND PROJECTOR LIGHT SOURCE BASED ON THESE MATERIALS

(71) Applicant: Sony Group Corporation, Tokyo (JP)

(72) Inventors: Nadejda KRASTEVA, Stuttgart (DE); Gabriele NELLES, Stuttgart (DE); Dennis CHERCKA, Stuttgart (DE); Clemens WALL, Stuttgart (DE)

(73) Assignee: Sony Group Corporation, Tokyo (JP)

(21) Appl. No.: 17/611,462

(22) PCT Filed: Mar. 13, 2020
(86) PCT No.: PCT/EP2020/056973

§ 371 Date: Nov. 15, 2021

(30) Foreign Application Priority Data
May 23, 2019 (EP) 19176156.8

(51) Int. Cl. C09K 11/02; C09K 11/88; C09K 5/14; C08K 9/10; C08J 5/18; G03B 21/20

(52) U.S. Cl. CPC C09K 11/025; C09K 11/883; C09K 5/14; B82Y 20/00; C08J 5/18; G03B 21/204; C08K 9/10

(57) ABSTRACT

Active materials for light emitting elements useful for light source apparatus and projector devices are provided. In particular, a light emitting element includes emissive semiconductor nano(crystal)material(s) (NC). Further, a light source apparatus, includes at least one light emitting element according to the present disclosure. The present disclosure also relates to a projector device, comprising a light source apparatus, comprising at least one light emitting element according to the present disclosure. Moreover, the present disclosure relates to methods of obtaining embedded semiconductor nano(crystal)material(s) and NC films.

### BACKGROUND

The field of the DISCLOSURE lies in active materials for light emitting elements useful for light source apparatus and projector devices.

The present disclosure relates to a light emitting element comprising emissive semiconductor nano(crystal)material(s) (NC).

The present disclosure also relates to a light source apparatus, comprising at least one light emitting element according to the present disclosure.

The present disclosure also relates to a projector device, comprising a light source apparatus, comprising at least one light emitting element according to the present disclosure.

Moreover, the present disclosure relates to methods of obtaining embedded semiconductor nano(crystal)material(s) and NC films.

### DESCRIPTION OF THE RELATED ART

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present disclosure.

In recent years, projector devices using solid state light sources, e.g. light emiting diodes LED or laser diodes LD, have become state-of-the-art technology. In some projector devices, LD are used as direct light sources, while in other cases the light from LD or LED source is used to excite an emissive material which emits photoluminescencent light within a specific wavelength range due to the excitation by the LD or LED light source.

Known emissive materials comprise inorganic phosphor materials, e.g. yellow-green emitting yttrium-aluminium-garnet (YAG) based material, or a combination of red and green emitting phosphor materials. A disadvantage of state-of-the-art inorganic phosphor materials is their broad emission spectrum (e.g. for YAG-based materials). Especially the limited emission in the red compared to the green spectral region leads to limitations in the achievable colour rendering index.

Semiconductor emissive nanocrystals (NC) are being explored as (electro-) luminescent materials in several lighting applications, e.g. LED or OLED flat-panel displays, as well as an active material in emissive display color filters.

A new/emerging application of NC materials is as an emissive source in projector devices, where the usage of NC materials aims improving the luminous efficacy and the color gamut compared to state-of-the-art inorganic phosphor materials used to date. The advantage of NC for projector application is their narrow spectral emission (FWHM ˜20-40 nm), high internal quantum efficiency (quantum yield (QY) up to ˜95%), as well as the possiblity to tune the emission wavelength in the visible range by changing the composition and the structure of the NC.

In one approach to realize a NC-based projector emissive source, the nanocrystals are dispersed in a matrix (polymeric or inorganic) to form a thin composite film. The NC are excited by an incident laser beam with a specific wavelength and at specific excitation power and the resulting photoluminescent light is collected. Typically a NC content of a few volume percent in the film is needed in order to achieve sufficient external quantum efficiency of the NC source, and to reach the required brightness and color gamut of the projector light source.

The internal quantum efficiency of emissive—nanocrystals—has achieved nearly 100%. However, the external quantum efficiency of NC-based light source remains below 15% because of losses due to concentration dependent multi-particle effects, e.g. re-absorption of the emitted photoluminescent light, emission quenching due to resonant energy transfer between neighbouring NC particles QD or non-radioactive relaxation processes (e.g. Auger recombination) or thermal quenching due to heating of the NC.

Further, the photoluminescence of pristine NC materials is degrading within a few minutes to few hours upon excitation with high light flux used in projector light source (typically in the range of several Watt/cm² to several kWatt/cm²). The limited photo stability of the native nanocrystals is attributed to degradation processes, e.g. oxidative processes caused by the presence of oxygen and/or humidity in the environment, as well as due to thermal degradation of the light-emissive NC material.

### SUMMARY

It is provided a light emitting element capable of obtaining a high output and having excellent structural stability, a light source apparatus including the light emitting element, and a projector.

The present disclosure provides a light emitting element, comprising emissive semiconductor nano(crystal)material(s).

The present disclosure provides a light source apparatus, comprising

(i) a light source, and

(ii) at least one light emitting element according to the present disclosure, or a plurality of light emitting elements according to the present disclosure.

The present disclosure provides a projector device, comprising

(i) a light source apparatus according to the present disclosure,

(ii) a light modulation element, and

(iii) a projection optical system.

The present disclosure provides a method of obtaining emissive semiconductor nano(crystal) material(s) (NC) encapsulated in a shell, comprising the steps of
providing NC material,
providing chemical precursors for the synthesis of the encapsulating shell,
providing pre-formed emulsion droplets serving as reaction containers,
incorporating the shell precursors into the pre-formed emulsion droplets
incorporating the NC material into the pre-formed emulsion droplets
carrying out a sol-gel chemical reaction in solution to form the shell using a reverse micro-emulsion procedure,
providing a procedure to purify and isolate the shell-encapsulated NC material, wherein the NC comprise elements of several groups of the periodic system, as defined herein, and/or wherein the shell material is a non-emissive material as defined herein.

The present disclosure provides a method of obtaining semiconductor nano(crystal) material(s) (NC) encapsulated in a monolith, comprising the steps of
providing semiconductor nano(crystal) material(s),
providing chemical precursors for the synthesis of the monolith,
carrying out a chemical reaction to form the monolith encapsulation of NC,
isolating the monolith encapsulated NC material
   wherein the NC comprise elements of several groups of the periodic system, as defined herein, and/or wherein the monolith material is a non-emissive material as defined herein.

The present disclosure provides a method of generating a thin layer or film comprising a NC material, a binder material, and optionally other additives, which are deposited on a substrate, said method comprising the steps of
mixing the NC material with the binder material
depositing the above mixture on the substrate by spin coating, drop casting, doctor blading, and/or screen printing,
curing of the deposited NC material/binder mixture.

The present disclosure provides a method of increasing the thermal conductivity of the light emitting element, comprising

(i) mechanical ad-mixing of high thermal conductivity materials to the NC/binder system, preferably as obtained with the method of generating a thin layer or film according to the present disclosure, or
(ii) co-incorporation of high-thermal conductivity materials and NC into the shell or monolith encapsulation matrix.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1A is a cross-sectional view illustrating a light emitting element (1) according to an embodiment of the present disclosure. FIG. 1B is a plane view illustrating the light emitting element (1) shown in FIG. 1A.

The light emitting element (1) has the shape of a wheel and is a light emitting element in which a reflective layer (3, with a surface (3S)) and a layer of emissive semiconductor nano(crystal) material (4) comprising NC (5) (and optionally binder (6)) are laminated in order on a surface (2S) of a base material (2) including a thin plate having a circular planar shape an opening (2K) is provided at the center of the base material (2). Further details are enclosed in U.S. Pat. No. 9,645,479 B2.

FIG. 2 is a cross-sectional view illustrating a configuration example of a light emitting element as a modification example.

The light emitting element (1A) is a light emitting element in which the layer of emissive semiconductor nano(crystal) material (4) is formed on a surface (2S1) of the base material 2. The surface (2S1) is a rough surface. The light emitting element (1A) is a so-called transmission type light emitting element: the base material (2) is configured of a transparent material and has a property of transmitting the excitation light (EL) with which a rear face (2S2) is irradiated on the side opposite to the surface (2S1).
Further details are enclosed in U.S. Pat. No. 9,645,479 B2.

FIG. 3 is a schematic view illustrating a configuration example of a light source apparatus (10) having a light emitting element (1) of the present disclosure.

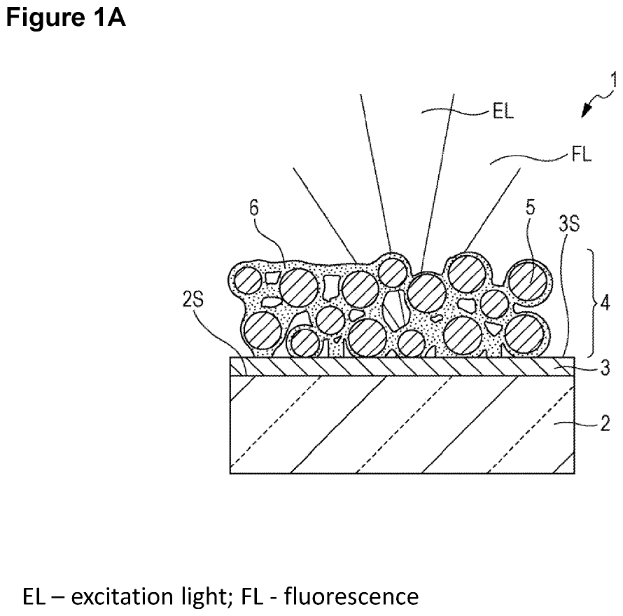

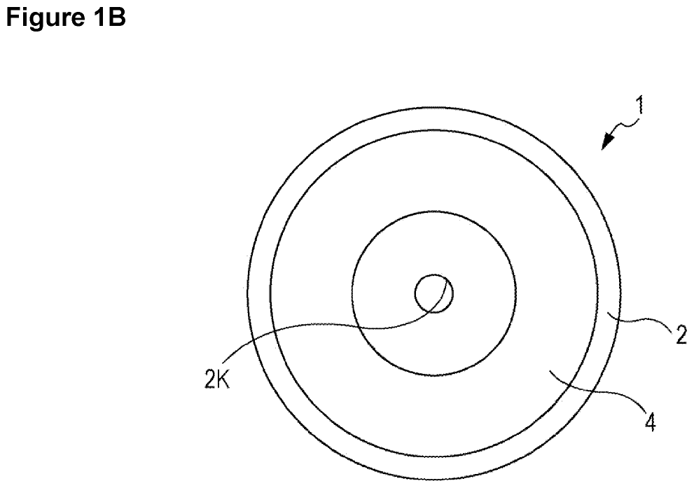

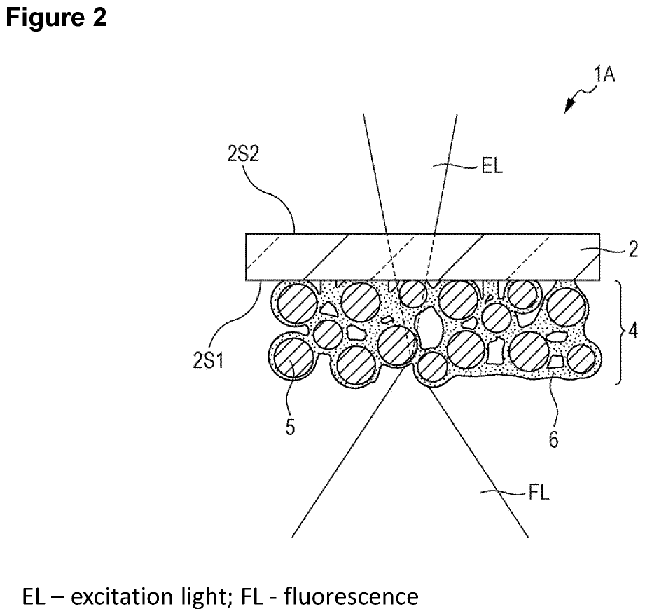

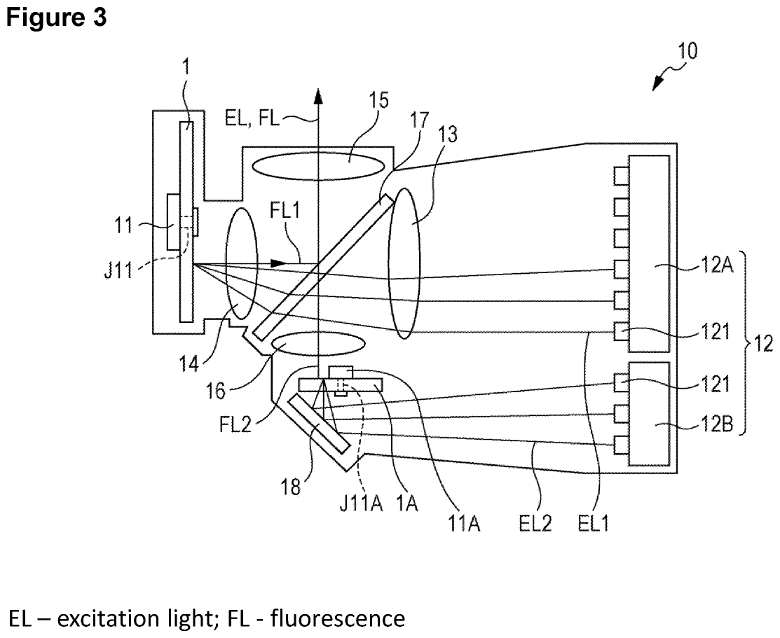

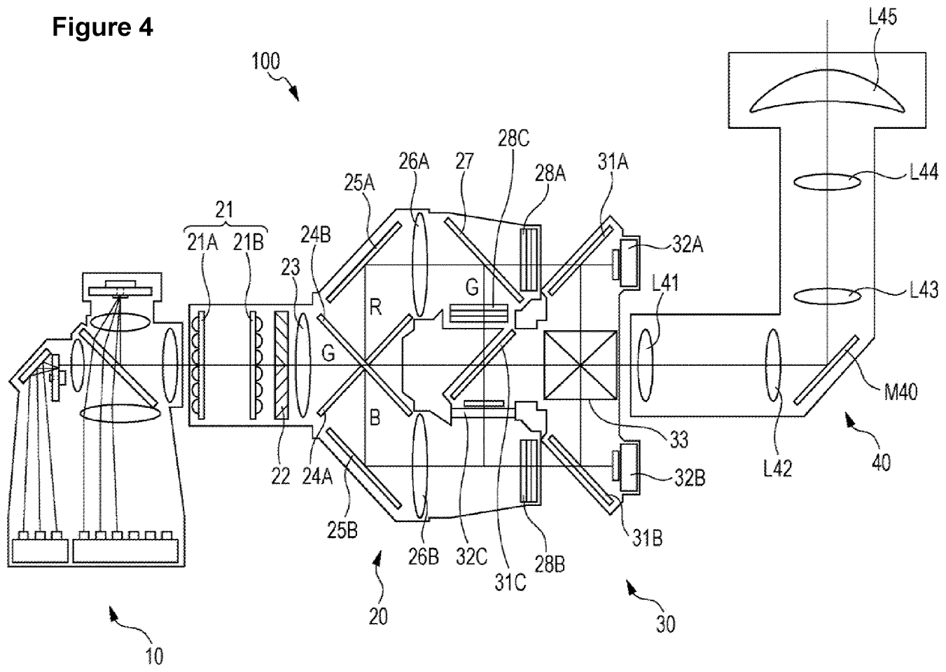

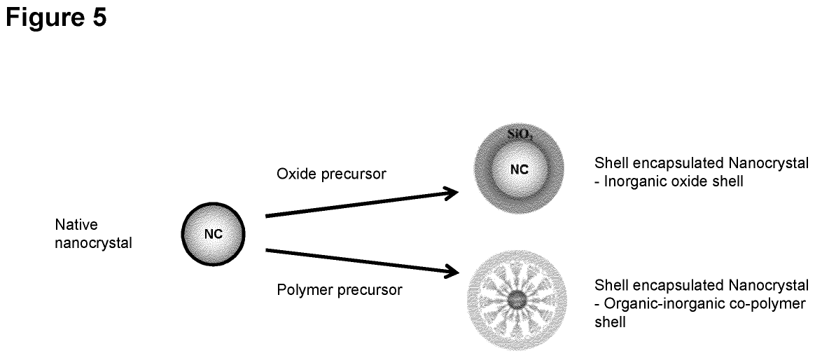

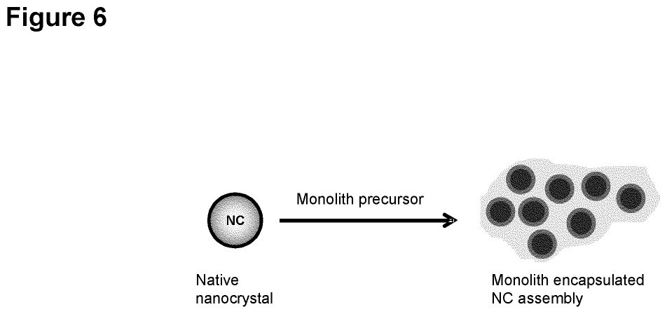

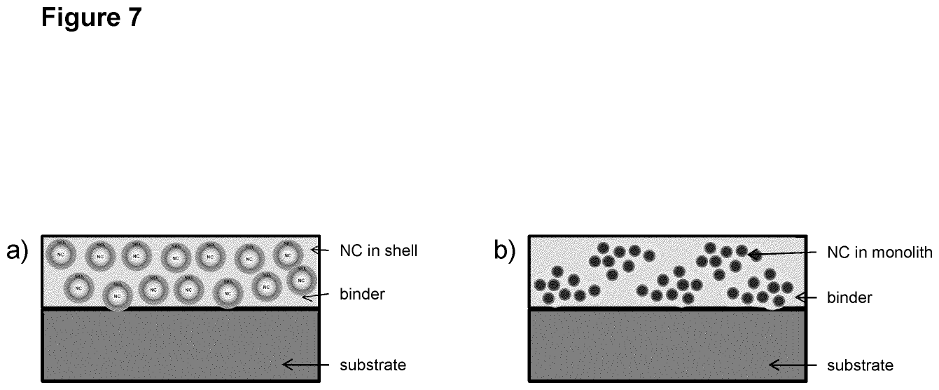

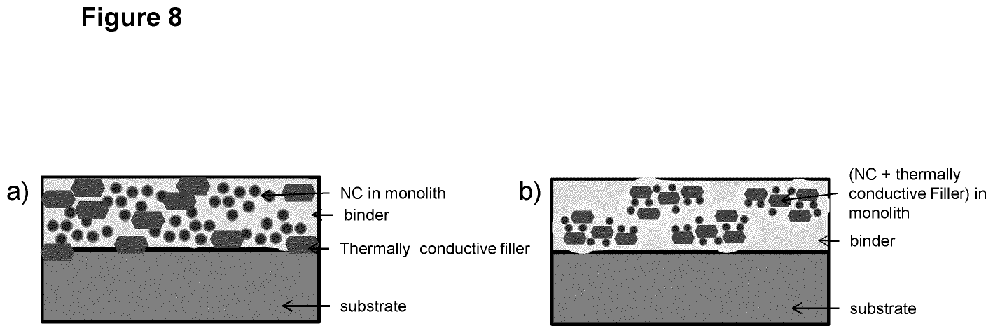

The light source apparatus (10) includes the light emitting elements (1) and (1A), a motor (11) including a rotation axis (J11), a motor (11A) including a rotation axis (J11A), a light source part (12) emitting the excitation light (EL), lenses (13 to 16), a dichroic mirror (17), and a reflection mirror (18). The light emitting element (1) is rotatably supported by the rotation axis (J11) and the light emitting element (1A) is rotatably supported by the rotation axis (J11A). The light source part (12) includes a first laser group (12A) and a second laser group (12B). Both of the first and the second laser groups (12A) and (12B) are groups in which a plurality of semiconductor laser elements (121) which oscillate blue laser light as excitation light. Here, for convenience, the excitation light oscillated from the first laser group (12A) is referred to as (EL1) and the excitation light oscillated from the second laser group (12B) is referred to as (EL2).

Further details are enclosed in U.S. Pat. No. 9,645,479 B2.

FIG. 4 is a schematic view illustrating a configuration example of a projector (100) including a light source apparatus (10) having a light emitting element (1) of the present disclosure.

The projector (100) includes the light source apparatus (10), the illumination optical system (20), an image forming part (30), and a projection optical system (40) in order.
The illumination optical system (20) includes, for example, a fly eye lens (21) (21A and 21B), a polarization conversion element (22), a lens (23), dichroic mirrors (24A and 24B), reflection mirrors (25A and 25B), lenses (26A and 26B), a dichroic mirror (27), and polarization plates (28A to 28C) from the position close to the light source apparatus (10).
The image forming part (30) includes reflection type polarization plates (31A to 31C), reflection type liquid crystal panels (32A to 32C), and a dichroic prism (33).
The projection optical system (40) includes lenses (L41 to L45) and a mirror (M40).
Further details are enclosed in U.S. Pat. No. 9,645,479 B2.

FIG. 5 shows a schematic representation of NC material encapsulation in protective shell.

FIG. 6 shows a schematic representation of NC material encapsulation in microscopic monolith structure.

FIG. 7 shows a schematic representation of NC/binder thin film on a solid support: a) shell-encapsulated NC; and b) monolith encapsulated NC.

FIG. 8 shows a schematic representation of the inclusion of thermally conductive materials into the NC layer on a solid support:

a) mechanical ad-mixing to the NC/binder system; and b) co-incorporation into the shell or monolith encapsulation matrix.

### DETAILED DESCRIPTION OF THE EMBODIMENTS

As discussed above, the internal quantum efficiency of semiconductor nanocrystals has achieved nearly 100%, whereas, the external quantum efficiency of the semiconductor nanocrystal based light source remains below ˜15% because of losses due to concentration dependent multi-particle effects, e.g. re-absorption of the emitted photoluminescent light, emission quenching due to resonant energy transfer between neighbouring nanocrystals or thermal quenching due to local heating of the nanocrystals.

Further, the photoluminescence of pristine emissive semiconductor nano(crystal) material is degrading within a few minutes to few hours upon excitation with high light flux used in projector source (typically in the range of several Watt/cm² to several kWatt/cm²). The limited photo stability of the native NC is attributed to oxidative processes caused by the presence of oxygen and/or humidity in the environment, as well as due to thermal degradation of the light-emissive NC material.

To achieve both high photo stability and high efficiency of the NC-based projector light source, a modification of the native NC and their implementation into appropriate film matrix is required in order to prevent both oxidative and thermal degradation.

The present disclosure provides a light emitting element. Said light emitting element comprises emissive semiconductor nano(crystal) material(s) as described herein.

The light emitting element emits photoluminescent light, by being excited with light emitted from a light source, such as in a light source apparatus of the present disclosure or a projector device of the present disclosure.

In one embodiment, said emissive semiconductor nano(crystal) material(s) comprising elements of several groups of the periodic system, such as but not limited to:

(i) type II/VI semiconductor materials,
such as CdS, CdSe, CdTe, ZnS, ZnSe, ZnTe, CdSe/ZnS, CdSe/CdS, CdSe/ZnSe, CdTe/CdS, CdTe/ZnS, CdTe/CdS/ZnS,

(ii) type BIN semiconductor materials,
such as InP, InAs, GaAs,

(iii) group IV-VI elements,
such as PbSe, PbS, PbTe,

(iv) group IB-(III)-VI elements,
such as CuInS₂, AgInS₂, Ag₂Se, Ag₂S; CuInZnS/ZnS,

(v) group IV elements,
such as silicon QDs (Si QDs), carbon dots (C-dots), graphene QDs (GQDs), and/or

(vi) organometallic halide perovskites,
such as
   Pb-based CsPbX₃; (CH₃NH₃)PbX₃, wherein X═Cl, Br, I, or their halide mixtures,
   Sn-based CsSnX₃, wherein X═Cl, Cl_{0.5}Br_{0.5}, Br, Br_{0.5}I_{0.5}, I,
   Ge-based (RbₓCs₁₋ₓ)GeBr₃; CsGe(BrₓCl₁₋ₓ)₃; CH₃NH₃GeX₃, wherein X═Cl, Br, I,
   Bi-based CsA₃Bi₂X₉, wherein X═Cl, Br, I; A=CH₃NH₃; (NH₄)₃Bi₂I₉; (CH₃NH₃)₃(Bi₂I₉),
   Sb-based (NH₄)₃Sb₂IₓBr₉₋ₓ (0<x<9); (CH₃NH₃)₃Sb₂I₉; Cs₃Sb₂I₉,
   InAg-based Cs₂InAgCl₆.

In one embodiment, said emissive semiconductor nano(crystal)material(s) have dimensional structure(s), such as

micron sized particles,

nanostructured particles
e.g.
three dimensional (3D) (bulk nanomaterials),
two-dimensional (2D) (nanoplatelets, nanodisks)
one-dimensional (1D) (nanorods, nanowires, nanofibers, nanobelts),
zero-dimensional (0D) (nanoparticles, nanodots, quantum dots) or

sub-nanometer sized emissive clusters.

In one embodiment, the NC are encapsulated in non-emissive material(s)

(a) in a shell, or

(b) in a monolith.

In one embodiment of the light emitting element, the NC are encapsulated (a) in a shell, wherein the structure is preferably core/shell, or core/shell/shell, wherein the core is preferably a single NC.

The process of shell encapsulation aims for the formation of a core/shell NC material with an example structure as shown in FIG. 5. Preferably, a structure comprising a single NC per shell is produced; the shell thickness can be varied from few nanometer up to −1 micrometer. Shell synthesis can be performed within pre-formed emulsion droplets serving as reaction containers, by e.g. sol-gel chemical process in solution using a reverse micro-emulsion procedure.

In said embodiment, the shell has a defined pore size, and the shell thickness is preferably in the range from 1 nm up to 1 μm.

Shell thickness can be between 1 nm and 1,000 nm, preferably between 20 nm and 100 nm. Shell porosity (expressed as minimum inner open voids size) is preferably between 0.001 nm and 0.5 nm.
Shell permeability to oxygen and humidity (expressed as oxygen transmission rate at 25° C. and 50% relative humidity) is preferably between 0.1 and 5 cm³/(m² day)

In said embodiment, the shell material is a non-emissive material selected from

(i) inorganic oxide or nitride materials,

such as
SiO₂, Al₂O₃, SiₓAl_{y}O_{z}, B₂O₃, ZrO₂, TiO₂, ZnO, SnO₂,
doped oxides with B, Al, Ti, Zn dopants
Si₄N₃, AlN, BN,
   and/or

(ii) polymer-based composite materials,

such as
organic-inorganic block-co-polymers,

The shell material has preferably a refractive index between 1 and 4, preferably between 1.2 and 2.5.

In said embodiment, the shell serves as a spacer to suppress resonant energy transfer between neighboring NC. The shell serves also as barrier to oxygen and/or humidity (H₂O) permeation from the environment.

In one embodiment of the light emitting element, the emissive semiconductor nano(crystal) material(s) are encapsulated (b) in a monolith, wherein preferably several NCs (>1 NC/monolith) are embedded into a monolith matrix.

The process of monolith encapsulation aims the formation of a NC-containing material, with example structure shown in FIG. 6. In this embodiment, microscopic crystals/flakes of NC assemblies embedded into a non-permeable matrix are formed. Preferably, single NC within the assembly are separated by thin layers of insulating non-emissive material from the monolith matrix.

Monolith Properties:
It is a spatially discrete microscopic object with homogeneous microstructure in which multiple NC are embedded;
Monolith object is characterized by its irregular shape, e.g. flake-like, platelet-like, needle-like, grain-like. Single NC within the monolith are separated by thin layers of material from the monolith matrix.
Size of the microscopic monolith objects can be between 0.2 μm and 1.000 μm, preferably between 1 μm and 20 μm.
Porosity (expressed as minimum inner open voids size) is between 0.001 nm and 0.5 nm.
Permeability to oxygen and humidity (expressed as oxygen transmission rate at 25° C. and 50% relative humidity) is between 0.1 and 5 cm³/(m² day)

In said embodiment, the monolith material is a non-emissive material selected from

(i) inorganic oxide or nitride materials,

such as
SiO₂, Al₂O₃, SiₓAl_{y}O_{z}, B₂O₃, ZrO₂, TiO₂, ZnO, SnO₂,
doped inorganic oxides with B, Al, Ti, Zn, dopants
Si₄N₃, AlN, BN,

(ii) polymer-based materials,

such as
inorganic polysilazanes [—H₂Si−NH-]ₙ,
   such as e.g. perhydropolysilazane
organic polysilazanes [—R₁R₂Si—NR₃—]ₙ, where R₁, R₂, R₃ are hydrocarbon substituents,
organic-inorganic silazane co-polymers,
   such as PMMA/polysilazane
organic-inorganic silica polymers,
   such as organically modified silicates, silsesquioxanes,
      and/or

(iii) single crystals,

such as
BaTiO₃, CaCO₃, BaSO₄, LiCl, LiF.

In one embodiment, the emissive semiconductor nano(crystal) material(s), preferably quantum dots (QD) further comprise support ligands.

In order to ensure high quantum yield (>50%) of the encapsulated NC, support ligands are preferably used to reduce the decrease of internal quantum efficiency (QY) during the encapsulation in shell and/or monolith.

In one embodiment, the support ligands are directly ad-mixed to the encapsulation reaction mixture during the encapsulation process and allowed to react with the NC nanocrystals typically before the shell or monolith formation.

In one embodiment, the support ligands are separately reacted with the initial NC material before encapsulation. In this case, a protective ligand shell on the NC is formed which is not exchanged during the encapsulation process, i.e. during the shell or monolith formation.

In said embodiment, said support ligands are added during encapsulation, or they form a ligand shell on the NC.

In said embodiment, the support ligands comprise:

(i) organic ligands,

such as
aliphatic or aromatic amine-terminated tri-,di- and mono-alkoxysilanes, such as
   aminopropyl tri-alkoxysilane, aminopropyl alkyl di-alkoxysilane, aminopropyl dialkyl mono-alkoxysilane,
aliphatic or aromatic mercapto-terminated tri-, di- and mono-alkoxysilanes, such as
   mercaptopropyl tri-alkoxysilane, mercaptopropyl alkyl di-alkoxysilane, mercapropropyl dialkyl mono-alkoxysilane,
aliphatic or aromatic amine-terminated tri-, di- and mono-silazanes R₃Si—[NH—SiR₂]ₙ—NH—SiR₃ (R═H, CₙH₂ₙ₊₁),
such as
   Hexamethyldisilazane, N-(Dimethylsilyl)-1,1-dimethylsilanamine, Methyl(phenyl)disilazane, Octamethylcyclotetrasiloxane,
aliphatic or aromatic amine-terminated or mercapro-terminated alcohols,
aliphatic or aromatic amine-terminated or mercapro-terminated carboxy acids,
aliphatic or aromatic amine-terminated or mercapro-terminated phosphines and phosphonic acids,
   and/or

(ii) inorganic ligands,

such as

(ii) inorganic ligands,

such as
inorganic metal-containing chalcogenides, e.g. Sn₂S₆⁴⁻, SnTe₄⁴⁻, AsS₃³⁻,
inorganic metal-free chalcogenides or hydrochalcogenides, e.g. S²⁻, HS⁻, Se²⁻, HSe⁻, Te²⁻, HTe⁻, TeS₃²⁻, S₂O₃²⁻,
inorganic hydroxyl- or amine-based compounds, e.g. OH⁻, and NH₂⁻.

In one embodiment, the light emitting element further comprise high-thermal conductivity material(s).

In said embodiment, said high-thermal conductivity material(s) are preferably co-incorporated into the shell or monolith encapsulation matrix together with the emissive semiconductor nano(crystal) material.

The high-thermal conductivity materials preferably comprise:

inorganic oxide materials,
such as SiO₂, Al₂O₃, SiₓAl_{y}O_{z}, ZrO₂, TiO₂, ZnO, SnO₂,

ceramic materials,
such as crystalline oxide, nitride or carbide ceramics, such as Al₄N₃, Si₄N₃, SiC, BN,

carbon-based materials,
such as carbon black, graphene, carbon nanotubes.

In one embodiment of the light emitting element, the emissive semiconductor nano(crystal) (NC) material(s) are deposited as a thin layer or film, comprising NC and binder material, on a substrate.

For preparation of the light emitting element, emissive semiconductor nano(crystal) material(s) are preferably deposited as a thin layer comprising both NC and binder material.

In said embodiment the thickness of the layer or film can be in the range of 1 μm to 1,000 μm, preferably 10 μm to 200 μm.

In said embodiment the loading of NC can be in the range of 0.0001% vol up to 95% vol, preferably between 0.01% vol and 80% vol.

In said embodiment the binder material(s) can be selected from, but are not limited to:

silicone resin polymers
such as methyl-silicone, phenyl-silicone, methyl-phenyl silicone resin, vinyl silicone resin, and mixtures thereof.

siloxane polymers,
such as methyl siloxane, phenyl siloxane, methyl phenyl siloxane,

thermoplastic polymers,
such as polycarbonate, polystyrene, polyacrylate, polymetylacrylate, polyetherimide, polysulfone, polyethersulfone, polyphenylethersulfone, polyvinylidenefluoride,

organic-inorganic silica polymers,
such as organically modified silicates, silsesquioxanes, inorganic oxide materials, such as SiO₂, Al²O³, SiₓAl_{y}O_{z}, ZrO², TiO², ZnO, SnO²,

inorganic polysilazanes,
such as perhydropolysilazane, silazane co-polymers,

ceramic materials,
such as crystalline oxide, nitride or carbide ceramics,

composite materials,
such as mixtures of ceramics, oxides, graphene, carbon nanotubes with one of the above mentioned binder materials.

In one embodiment, the thermal conductivity of the thin layer or film of the light emitting element can be in the range from about 1 W/K.m to more than 30 W/K.m. Said thermal conductivity serves to achieve good thermal dissipation within the light emitting element.

In one embodiment, high thermal conductivity material(s) are mechanically admixed to the NC/binder system.

The high-thermal conductivity materials preferably comprise:

inorganic oxide materials,
such as SiO₂, Al₂O₃, SiₓAl_{y}O_{z}, ZrO₂, TiO₂, ZnO, SnO₂,

ceramic materials,
such as crystalline oxide, nitride or carbide ceramics, such as Al₄N₃, Si₄N₃, SiC, BN,

carbon-based materials,
such as carbon black, graphene, carbon nanotubes.

In one embodiment, the light emitting element further comprises a substrate material having a reflective surface.

As discussed above, the present disclosure provides a light source apparatus, comprising

(i) a light source, and

(ii) at least one light emitting element according to the present disclosure, or a plurality of light emitting elements according to the present disclosure.

In one embodiment, the light source is a laser diode, preferably a blue laser diode, or a plurality of laser diodes configured in an array.

Further details are enclosed e.g. in U.S. Pat. No. 9,645,479 B2.

The light emitting element emits photoluminescent light by being excited with light emitted from the light source.

As discussed above, the present disclosure provides a projector device, comprising

(i) a light source apparatus according to the present disclosure,

(ii) a light modulation element, and

(iii) a projection optical system.

The light modulation element modulates light which is ejected from the light source apparatus. The projection optical system projects light from the light modulation element.

Further details are enclosed e.g. in U.S. Pat. No. 9,645,479 B2.

In one embodiment the projector device can be a projection type image display apparatus which projects a screen of a personal computer, a video footage, or the like on a screen.

As discussed above, the present disclosure provides a method of obtaining semiconductor nano(crystal) materials (NC) encapsulated in a shell, comprising the steps of
providing NC materials,
providing chemical precursors for the synthesis of the encapsulating shell,
providing pre-formed emulsion droplets serving as reaction containers,
incorporating the shell precursors into the pre-formed emulsion droplets
incorporating the NC material into the pre-formed emulsion droplets
carrying out a sol-gel chemical reaction in solution to form the shell using a reverse micro-emulsion procedure,
providing a procedure to purify and isolate the shell-encapsulated NC material.

In one embodiment, the NC comprise elements of several groups of the periodic system, as defined herein,

and/or wherein the shell material is a non-emissive material as defined herein.

As discussed above, the present disclosure provides a method of obtaining emissive semiconductor nano(crystal) material(s) (NC) encapsulated in a monolith, comprising the steps of
providing NC material(s),
providing chemical precursors for the synthesis of the monolith,
carrying out a chemical reaction to form the monolith encapsulation of NC,
isolating the monolith encapsulated NC material.

In one embodiment, the NC comprise elements of several groups of the periodic system, as defined herein, and/or wherein the monolith material is a non-emissive material as defined herein.

In one embodiment, the methods further comprise the use of support ligands during the encapsulation, wherein

(i) the support ligands are directly ad-mixed to the encapsulation reaction mixture during the encapsulation process and allowed to react with the emissive semiconductor nano(crystal) material(s) typically before the shell or monolith formation; or

(ii) the support ligands are separately reacted with the initial NC material prior to the encapsulation, such that a protective ligand shell on the NC is formed which is not exchanged during the encapsulation process, i.e. during the shell or monolith formation.

In one embodiment, the support ligands comprise organic ligands and/or inorganic ligands as defined herein.

As discussed above, the present disclosure provides a method of generating a thin layer or film comprising emissive semiconductor nano(crystal) material(s), a binder material, and optionally other additives, which are deposited on a substrate.

In one embodiment, the substrate is a flat piece of glass, ceramic or metal material with reflective surface.

In one embodiment, the NC material is one of non-modified pristine NC nanocrystals, NC encapsulated in shell, and/or NC encapsulated in monolith.

In one embodiment, the binder material serves to hold the NC material and/or the other additives together, and at the same time ensures a good adhesion of the NC film to the substrate.

In one embodiment, the binder material(s) are as defined herein.

The light emitting element thin film characteristics are preferably:
film thickness between 0.100μ and 2000 μm, preferably 50 μm to 1000 μm, most preferably 100 μm to 500 μm.

The method of generating a thin layer or film comprises:
mixing the NC material with the binder material
depositing the above mixture on the substrate by spin coating, drop casting, doctor blading, and/or screen printing,
curing of the deposited NC material/binder mixture.

Binder curing is done by heat exposure (thermal curing), UV exposure (UV curing), and/or chemical curing.

In one embodiment, binder curing conditions for film preparation are between complete inert (0% oxygen, 0% relative humidity) to ambient (21% oxygen, up to 100% relative humidity); and/or temperature of binder curing is between ambient (22° C.) and 180° C.; and/or UV exposure for binder curing is between 1 J/cm² and 16 kJ/cm² preferably between 10 J/cm² and 10 J/cm².

As discussed above, the present disclosure provides a method of increasing the thermal conductivity of light emitting element, comprising

(i) mechanical ad-mixing of high thermal conductivity materials to the NC/binder system, preferably as obtained with the method of generating a thin layer or film (see above) the present disclosure,

or

(ii) co-incorporation of high-thermal conductivity materials and NC into the shell or monolith encapsulation matrix, preferably as obtained with one of the methods of the present disclosure.

The high-thermal conductivity materials preferably comprise:

inorganic oxide materials,
such as SiO₂, Al₂O₃, SiₓAl_{y}O_{z}, ZrO₂, TiO₂, ZnO, SnO₂,

ceramic materials,
such as crystalline oxide, nitride or carbide ceramics, such as Al₄N₃, Si₄N₃, SiC, BN,

carbon-based materials,
such as carbon black, graphene, carbon nanotubes.

Note that the present technology can also be configured as described below.

(1) A light emitting element

comprising emissive semiconductor nano(crystal) material(s) (NC).

(2) The light emitting element of embodiment (1), wherein the nano(crystal) material(s) (NC) are encapsulated in non-emissive material(s)

(a) in a shell, or

(b) in a monolith.

(3) The light emitting element of embodiment (1) or (2), wherein said emissive semiconductor NC comprise elements of several groups of the periodic system, such as but not limited to:

(i) type II/VI semiconductor materials,
such as CdS, CdSe, CdTe, ZnS, ZnSe, ZnTe, CdSe/ZnS, CdSe/CdS, CdSe/ZnSe, CdTe/CdS, CdTe/ZnS, CdTe/CdS/ZnS,

(ii) type III/V semiconductor materials,
such as InP, InAs, GaAs,

(iii) group IV-VI elements,
such as PbSe, PbS, PbTe,

(iv) group IB-(III)-VI elements,
such as CuInS₂, AgInS₂, Ag₂Se, Ag₂S; CuInZnS/ZnS,

(v) group IV elements,
such as silicon QDs (Si QDs), carbon dots (C-dots), graphene QDs (GQDs), and/or

(vi) organometallic halide perovskites,

such as
Pb-based CsPbX₃; (CH₃NH₃)PbX₃, wherein X═Cl, Br, I, or their halide mixtures,
Sn-based CsSnX₃, wherein X═Cl, Cl_{0.5}Br_{0.5}, Br, Br_{0.5}I_{0.5}, I,
Ge-based (RbₓCs₁₋ₓ)GeBr₃; CsGe(BrₓCl₁₋ₓ)₃; CH₃NH₃GeX₃, wherein X═Cl, Br, I,
Bi-based CsA₃Bi₂X₉, wherein X═Cl, Br, I; A=CH₃NH₃; (NH);Bi₂I₉; (CH₃NH₃)₃(Bi₂I₉),
Sb-based (NH₄)₃Sb₂IₓBr₉₋ₓ (0<x<9); (CH₃NH₃)₃Sb₂I₉: Cs₃Sb₂I₉,
InAg-based Cs₂InAgCl₆.
   (4) The light emitting element of any one of embodiments (1) to (3), wherein said emissive semiconductor NC have dimensional structure(s),
   such as micron sized particles, nanostructured particles e.g. three dimensional (3D) (bulk nanomaterials), two-dimensional (2D) (nanoplatelets, nanodisks) one-dimensional (1D) (nanorods, nanowires, nanofibers, nanobelts), zero-dimensional (0D) (nanoparticles, nanodots, quantum dots) or sub-nanometer sized emissive clusters.
   (5) The light emitting element of any one of embodiments (1) to (4), wherein the nano(crystal) material(s) (NC), are encapsulated (a) in a shell,
   wherein the structure of the resulting encapsulated material is core/shell, or core/shell/shell, wherein the core is preferably a single NC particle,
   wherein, preferably, the shell thickness is in the range from 1 nm up to 1 μm, more preferably between 20 nm and 100 nm, and/or shell porosity (expressed as minimum inner open voids size) is preferably between 0.001 nm and 0.5 nm.
   wherein the shell material is a non-emissive material selected from

(i) inorganic oxide or nitride materials,

such as
SiO₂, Al₂O₃, SiₓAl_{y}O_{z}, B₂O₃, ZrO₂, TiO₂, ZnO, SnO₂,
doped oxides with B, Al, Ti, Zn dopants
Si₄N₃, AlN, BN,
   and/or

(ii) polymer-based composite materials,

such as
organic-inorganic block-co-polymers,
   and/or wherein, preferably, the shell material has a refractive index between 1 and 4, preferably between 1.2 and 2.5,
   and/or wherein the shell serves as a spacer.
   (6) The light emitting element of any one of embodiments (1) to (4), wherein the nano(crystal) material(s) (NC), are encapsulated (b) in a monolith,
   wherein the several NCs (>1 NC/monolith) are embedded into a monolith matrix, wherein preferably single NC within the assembly are separated by thin layers of insulating non-emissive material from the monolith matrix,
   wherein the monolith material is a non-emissive material selected from

(i) inorganic oxide or nitride materials,

such as
SiO₂, Al₂O₃, SiₓAl_{y}O_{z}, B₂O₃, ZrO₂, TiO₂, ZnO, SnO₂,
doped oxides with B, Al, Ti, Zn dopants
Si₄N₃, AlN, BN,

(ii) polymer-based materials,

such as
inorganic polysilazanes [—H₂Si—NH— ]ₙ,
   such as e.g. perhydropolysilazane
organic polysilazanes [—R₁R₂Si—NR₃—]ₙ, where R₁, R₂, R₃ are hydrocarbon substituents,
organic-inorganic silazane co-polymers,
   such as PMMA/polysilazane
organic-inorganic silica polymers,
   such as organically modified silicates, silsesquioxanes,
      and/or

(iii) single crystals,

such as
BaTiO₃, CaCO₃, BaSO₄, LiCl, LiF.
   (7) The light emitting element of any one of embodiments (1) to (4), wherein said emissive semiconductor nano(crystal) material(s) (NC), preferably quantum dots (QD) further comprise support ligands,
   wherein said support ligands are added during encapsulation, or they form a ligand shell on the NC prior to encapsulation,
   wherein the support ligands comprise:

(i) organic ligands,

such as
aliphatic or aromatic amine-terminated tri-, di- and mono-alkoxysilanes, such as
   aminopropyl tri-alkoxysilane, aminopropyl alkyl di-alkoxysilane, aminopropyl dialkyl mono-alkoxysilane,
aliphatic or aromatic mercapto-terminated tri-, di- and mono-alkoxysilanes, such as
   mercaptopropyl tri-alkoxysilane, mercaptopropyl alkyl di-alkoxysilane, mercapropropyl dialkyl mono-alkoxysilane,
aliphatic or aromatic amine-terminated tri-, di- and mono-silazanes R₃Si—[NH—SiR₂]ₙ—NH—SiR₃ (R═H, CₙH₂ₙ₊₁),
such as
   Hexamethyldisilazane, N-(Dimethylsilyl)-1,1-dimethylsilanamine, Methyl(phenyl)disilazane, Octamethylcyclotetrasiloxane,
aliphatic or aromatic amine-terminated or mercapro-terminated alcohols,
aliphatic or aromatic amine-terminated or mercapro-terminated carboxy acids,
aliphatic or aromatic amine-terminated or mercapro-terminated phosphines and phosphonic acids,
   and/or

(ii) inorganic ligands,

such as
inorganic metal-containing chalcogenides, e.g. Sn₂S₆⁴⁻, SnTe₄⁴⁻, AsS₃³⁻
inorganic metal-free chalcogenides or hydrochalcogenides, e.g. S²⁻, HS⁻, Se²⁻, HSe⁻, Te²⁻, HTe⁻, TeS₃²⁻, S₂O₃²⁻,
inorganic hydroxyl- or amine-based compounds, e.g. OH⁻ and NH₂⁻.
   (8) The light emitting element of any one of embodiments (1) to (7), wherein said emissive semiconductor nano(crystal) material(s) (NC) further comprise high-thermal conductivity material(s),
   which are preferably co-incorporated into the shell or monolith encapsulation matrix,
   and/or wherein the high-thermal conductivity materials preferably comprise:

inorganic oxide materials,
such as SiO₂, Al₂O₃, SiₓAl_{y}O_{z}, ZrO₂, TiO₂, ZnO, SnO₂,

ceramic materials,
such as crystalline oxide, nitride or carbide ceramics, such as Al₄N₃, Si₄N₃, SiC, BN,

carbon-based materials,
such as carbon black, graphene, carbon nanotubes.
   (9) The light emitting element of any one of embodiments (1) to (8), wherein the emissive semiconductor nano(crystal) material(s) (NC) are deposited as a thin layer or film, comprising NC and binder material, on a substrate.
   (10) The light emitting element of embodiment (9), wherein
the thickness of the layer or film is in the range of 1 to 1,000 μm, preferably 10 to 200 μm, and/or
the loading of NC is in the range of 0.0001% vol up to 95% vol, preferably between 0.01% vol and 80% vol,
   and/or the binder material(s) can be selected from, but are not limited to:

silicone resin polymers
such as methyl-silicone, phenyl-silicone, methyl-phenyl silicone resin, vinyl silicone resin, and mixtures thereof

siloxane polymers,
such as methyl siloxane, phenyl siloxane, methyl phenyl siloxane,

thermoplastic polymers,
such as polycarbonate, polystyrene, polyacrylate, polymetylacrylate, polyetherimide, polysulfone, polyethersulfone, polyphenylethersulfone, polyvinylidenefluoride,

organic-inorganic silica polymers,
such as organically modified silicates, silsesquioxanes,

inorganic oxide materials,
such as SiO₂, Al₂O₃, SiₓAl_{y}O_{z}, ZrO₂, TiO₂, ZnO, SnO₂,

inorganic polysilazanes,
such as perhydropolysilazane, silazane co-polymers,

ceramic materials,
such as crystalline oxide, nitride or carbide ceramics,

composite materials,
such as mixtures of ceramics, oxides, graphene, carbon nanotubes with one of the above mentioned binder materials.
   (11) The light emitting element of embodiment (9) or (10), wherein the thermal conductivity of the NC thin layer or film is in the range from about 1 W/K·m to more than 30 W/K·m,
   wherein high thermal conductivity material(s) are mechanically admixed to the QD/binder system,
   and/or wherein the high-thermal conductivity materials preferably comprise:

inorganic oxide materials,
such as SiO₂, Al₂O₃, SiₓAl_{y}O_{z}, ZrO₂, TiO₂, ZnO, SnO₂,

ceramic materials,
such as crystalline oxide, nitride or carbide ceramics, such as Al₄N₃, Si₄N₃, SiC, BN,

carbon-based materials,
such as carbon black, graphene, carbon nanotubes.
   (12) The light emitting element of any of the preceding embodiments, further comprising a substrate material having a reflective surface.
   (13) A light source apparatus, comprising

(i) a light source, and

(ii) at least one light emitting element according to any one of embodiments (1) to (12), or a plurality of light emitting elements according to any one of embodiments (1) to (12).

(14) A projector device, comprising

(i) a light source apparatus according to embodiment (13),

(ii) a light modulation element, and

(iii) a projection optical system.

(15) A method of obtaining emissive semiconductor nano(crystal) material(s) (NC) encapsulated in a shell, comprising the steps of
providing NC material(s),
providing chemical precursors for the synthesis of the encapsulating shell,
providing pre-formed emulsion droplets serving as reaction containers,
incorporating the shell precursors into the pre-formed emulsion droplets
incorporating the NC into the pre-formed emulsion droplets
carrying out a sol-gel chemical reaction in solution to form the shell using a reverse micro-emulsion procedure,
providing a procedure to purify and isolate the shell-encapsulated NC material,
   wherein the NC comprise elements of several groups of the periodic system, as defined in embodiment (3),
   and/or wherein the shell material is a non-emissive material as defined in embodiment (5).
   (16) A method of obtaining emissive semiconductor nano(crystal)material(s) (NC) encapsulated in a monolith, comprising the steps of

providing NC material(s),

providing chemical precursors for the synthesis of the monolith,

carrying out a chemical reaction to form the monolith encapsulation of NC,

isolating the monolith encapsulated NC material,

wherein the NC comprise elements of several groups of the periodic system, as defined in embodiment (3),
and/or wherein the monolith material is a non-emissive material as defined in embodiment (6).
(17) The method of embodiment (15) or (16), comprising the use of support ligands during the encapsulation, wherein

(i) the support ligands are directly ad-mixed to the encapsulation reaction mixture during the encapsulation process and allowed to react with the NC nanocrystals typically before the shell or monolith formation; or

(ii) the support ligands are separately reacted with the initial NC material prior to the encapsulation, such that a protective ligand shell on the NC is formed which is not exchanged during the encapsulation process, i.e. during the shell or monolith formation,

and wherein the support ligands comprise organic ligands and/or inorganic ligands as defined in embodiment (7).
(18) A method of generating a thin layer or film comprising semiconductor nano(crystal) materials, a binder material, and optionally other additives, which are deposited on a substrate,
said method comprising the steps of
mixing the NC material with the binder material
depositing the above mixture on the substrate by spin coating, drop casting, doctor blading, and/or screen printing,
curing of the deposited NC material/binder mixture,
   wherein, preferably, binder curing conditions for film preparation are between complete inert (0% oxygen, 0% relative humidity) to ambient (21% oxygen, up to 100% relative humidity); and/or temperature of binder curing is between ambient (22° C.) and 180° C.; and/or UV exposure for binder curing is between 1 J/cm2 and 16 kJ/cm² preferably between 10 J/cm² and 10 J/cm²,
   wherein the binder material(s) are as defined in embodiment (10).
   (19) A method of increasing the thermal conductivity of the light emitting element, comprising

(i) mechanical ad-mixing of high thermal conductivity materials to the NC/binder layer, preferably as obtained with the method of embodiment (18),

or

(ii) co-incorporation of high-thermal conductivity materials and NC into the shell or monolith encapsulation matrix, preferably as obtained with a method of any one of embodiments (15) to (17),

wherein the high-thermal conductivity material(s) preferably comprise:
inorganic oxide materials, such as SiO₂, Al₂O₃, SixAlyOz, ZrO₂, TiO₂, ZnO, SnO₂,
ceramic materials, such as crystalline oxide, nitride or carbide ceramics, such as Al₄N₃, Si₄N₃, SiC, BN,
carbon-based materials, such as carbon black, graphene, carbon nanotubes.

The term “semiconductor nano(crystal) material (NC)”, as used herein, refers semiconductor nanocrystals which can emit pure monochromatic red, green, and blue light.

The term “shell”, as used herein, refers to a spatially discrete object in which preferably single NC particles are embedded; the shape of the shell could be spherical, spheroid, rod-like, disk-like, and platelet-like.

The term “monolith”, as used herein, refers to a matrix which is not spherical and is not a bead. A monolith is a semi-dimensional structure which could be described as a flake. A “monolith” is understood as a spatially discrete microscopic object with homogeneous microstructure in which multiple NC particles are embedded; monolith object is characterized by its irregular shape, e.g. flake-like, platelet-like, needle-like, grain-like. Single NC particles within the monolith are separated by thin layers of material from the monolith matrix. Size of the microscopic monolith objects can be between 0.2 μm and 1000 μm, preferably between 1 μm and 20 μm.

The present invention relates to semiconductor nano(crystal) material(s) emissive materials as light emitting material implemented in a solid state projector light source with the purpose to improve the stability, the quantum efficiency, the spectral properties and the colour rendering capabilities.

Furthermore, the present invention is related to a projector light source using such emissive materials.

The present disclosure provides the following features:
NC emissive materials with improved photo stability at excitation power >1 W/cm².
NC emissive materials with internal quantum efficiency (quantum yield) >50%.
light emitting element with improved external quantum efficiency, photo stability and thermal stability based on the above mentioned NC emissive materials.
Projector light source with improved luminous efficacy, photostability, and thermal stability based on the above mentioned light emitting element.

The present disclosure provides:
High photostability of NC emissive material at high light flux excitation;
High external quantum efficiency;
High thermal conductivity of emissive source;
Solution-based processing possible/no vacuum technique needed.

### EXAMPLES

### Example 1

Examples for Photostability Improvement Through Encapsulation of QD:

Improvement of photostability of Cd-based NC through encapsulation is demonstrated by the following examples (Table 1).

The photostability of the NC material was assessed as the loss of photoluminescence intensity after 24 h excitation with continuous wave laser diode (LD) array, using excitation wavelength 450 nm.

TABLE 1
Photostability comparison of non-encapsulated and encapsulated
NC materials, measured as the loss of photoluminescence intensity
after 24 h excitation at excitation wavelength 450 nm

| | | | | Loss of | |
|---|---|---|---|---|---|
| | | | | photolu- | |
| | | | | minescence | Photo- |
| | Encapsu- | Encapsu- | Binder | intensity | stability |
| | lation | lation | for film | after 24 h | improve- |
| QD type | type | material | making | excitation | ment |
| CdSeZnS | none | none | silicone | 75% | — |
| | | | resin | | |
| CdSeZnS | shell | Al₂O₃ | silicone | 35% | 214% |
| | | | resin | | |
| CdSeZnS | monolith | Polysilazane | silicone | 10% | 750% |
| | | polymer | resin | | |

1. A light emitting element, comprising:
emissive semiconductor nano(crystal) (NC) materials.

2. The light emitting element of claim 1, wherein the NC materials are encapsulated in non-emissive materials in a shell, or in a monolith.

3. The light emitting element of claim 1, wherein said emissive semiconductor NC materials comprise elements from several groups of the periodic system, the groups including:
(i) type II/VI semiconductor materials, including CdS, CdSe, CdTe, ZnS, ZnSe, ZnTe, CdSe/ZnS, CdSe/CdS, CdSe/ZnSe, CdTe/CdS, CdTe/ZnS, and CdTe/CdS/ZnS,
(ii) type III/V semiconductor materials, including InP, InAs, and GaAs,
(iii) group IV-VI elements, including PbSe, PbS, and PbTe,
(iv) group IB-(III)-VI elements, including CuInS₂, AgInS₂, Ag₂Se, Ag₂S, and CuInZnS/ZnS,
(v) group IV elements, including silicon QDs (Si QDs), carbon dots (C-dots), and graphene QDs (GQDs),
and
(vi) organometallic halide perovskites, including
Pb-based CsPbX₃; (CH₃NH₃)PbX₃, wherein X═Cl, Br, I, or their halide mixtures,
Sn-based CsSnX₃, wherein X═Cl, Cl_{0.5}Br_{0.5}, Br, Br_{0.5}I_{0.5}, I,
Ge-based (RbₓCs₁₋ₓ)GeBr₃; CsGe(BrₓCl₁₋ₓ)₃; CH₃NH₃GeX₃, wherein X═Cl, Br, I,
Bi-based CsA₃Bi₂X₉, wherein X═Cl, Br, I; A=CH₃NH₃; (NH₄)₃Bi₂I₉; (CH₃NH₃)₃(Bi₂I₉),
Sb-based (NH₄)₃Sb₂IₓBr₉₋ₓ (0<x<9); (CH₃NH₃)₃Sb₂I₉, Cs₃Sb₂I₉, and
InAg-based Cs₂InAgCl₆.

4. The light emitting element of claim 1, wherein said emissive semiconductor NC materials have dimensional structures, including
micron sized particles, nanostructured particles including three dimensional (3D) (bulk nanomaterials), two-dimensional (2D) (nanoplatelets, nanodisks) one-dimensional (1D) (nanorods, nanowires, nanofibers, nanobelts), zero-dimensional (0D) (nanoparticles, nanodots, quantum dots), or sub-nanometer sized emissive clusters.

5. The light emitting element of claim 1, wherein the NC materials are encapsulated in a shell,
wherein the structure of the resulting encapsulated material is core/shell, or core/shell/shell,
wherein the core is a single NC particle,
wherein the shell thickness is in the range from 1 nm up to 1 μm, and/or shell porosity, expressed as minimum inner open voids size, is between 0.001 nm and 0.5 nm,
wherein the shell material is a non-emissive material selected from at least one of
(i) inorganic oxide or nitride materials, including
SiO₂, Al₂O₃, SiₓAl_{y}O_{z}, B₂O₃, ZrO₂, TiO₂, ZnO, and SnO₂,
doped oxides with B, Al, Ti, Zn dopants, and
Si₄N₃, AlN, and BN,
and
(ii) polymer-based composite materials, including
organic-inorganic block-co-polymers,
wherein the shell material has a refractive index between 1 and 4, and
wherein the shell serves as a spacer.

6. The light emitting element of claim 1, wherein the NC materials are encapsulated in a monolith,
wherein the several NCs (>1 NC/monolith) are embedded into a monolith matrix,
wherein single NC within the assembly are separated by thin layers of insulating non-emissive material from the monolith matrix, and
wherein the monolith material is a non-emissive material selected from at least one of
(i) inorganic oxide or nitride materials, including
SiO₂, Al₂O₃, SiₓAl_{y}O_{z}, B₂O₃, ZrO₂, TiO₂, ZnO, and SnO₂,
doped oxides with B, Al, Ti, and Zn dopants, and
Si₄N₃, AlN, and BN,
(ii) polymer-based materials, including
inorganic polysilazanes [—H₂Si—NH—]ₙ, including e.g. perhydropolysilazane,
organic polysilazanes [—R₁R₂Si—NR₃—]ₙ, where R₁, R₂, R₃ are hydrocarbon substituents,
organic-inorganic silazane co-polymers, including PMMA/polysilazane,
organic-inorganic silica polymers, including organically modified silicates, silsesquioxanes,
and
(iii) single crystals, including
BaTiO₃, CaCO₃, BaSO₄, LiCl, and LiF.

7. The light emitting element of claim 1, wherein said emissive semiconductor NC materials include quantum dots (QD) and further comprise support ligands,
wherein said support ligands are added during encapsulation, or form a ligand shell on the NC prior to encapsulation, and
wherein the support ligands comprise at least one of:
(i) organic ligands, including
aliphatic or aromatic amine-terminated tri-, di- and mono-alkoxysilanes, including
aminopropyl tri-alkoxysilane, aminopropyl alkyl di-alkoxysilane, aminopropyl dialkyl mono-alkoxysilane,
aliphatic or aromatic mercapto-terminated tri-, di- and mono-alkoxysilanes, including
mercaptopropyl tri-alkoxysilane, mercaptopropyl alkyl di-alkoxysilane, mercapropropyl dialkyl mono-alkoxysilane,
aliphatic or aromatic amine-terminated tri-, di- and mono-silazanes R₃Si—[NH—SiR₂]ₙ—NH—SiR₃ (R═H, CₙH₂ₙ₊₁), including
Hexamethyldisilazane, N-(Dimethylsilyl)-1,1-dimethyl silanamine, Methyl(phenyl)disilazane, Octamethylcyclotetrasiloxane,
aliphatic or aromatic amine-terminated or mercapro-terminated alcohols,
aliphatic or aromatic amine-terminated or mercapro-terminated carboxy acids, and
aliphatic or aromatic amine-terminated or mercapro-terminated phosphines and phosphonic acids,
and
(ii) inorganic ligands, including
inorganic metal-containing chalcogenides, including Sn₂S₆⁴⁻, SnTe₄⁴⁻, and AsS₃³⁻,
inorganic metal-free chalcogenides or hydrochalcogenides, including S²⁻, HS⁻, Se²⁻, HSe⁻, Te²⁻, HTe⁻, TeS₃²⁻, and S₂O₃²⁻, and
inorganic hydroxyl- or amine-based compounds, including OH⁻, and NH₂⁻.

8. The light emitting element of claim 1, wherein said emissive semiconductor NC materials further comprise high-thermal conductivity materials, which are co-incorporated into the shell or monolith encapsulation matrix, and
wherein the high-thermal conductivity materials comprise at least one of:
inorganic oxide materials, including SiO₂, Al₂O₃, SiₓAl_{y}O_{z}, ZrO₂, TiO₂, ZnO, and SnO₂,
ceramic materials, including crystalline oxide, nitride or carbide ceramics, such as Al₄N₃, Si₄N₃, SiC, and BN, and
carbon-based materials, including carbon black, graphene, and carbon nanotubes.

9. The light emitting element of claim 1, wherein the emissive semiconductor NC materials are deposited as a thin layer or film, comprising NC and binder material, on a substrate,
wherein
the thickness of the layer or film is in the range of 1 to 1,000 μm, and/or
the loading of NC is in the range of 0.0001% vol up to 95% vol, and/or
the binder material(s) can be selected from at least one of:
silicone resin polymers including methyl-silicone, phenyl-silicone, methyl-phenyl silicone resin, vinyl silicone resin, and mixtures thereof,
siloxane polymers, including methylsiloxane, phenylsiloxane, and methyl phenyl siloxane,
thermoplastic polymers, including polycarbonate, polystyrene, polyacrylate, polymetylacrylate, polyetherimide, polysulfone, polyethersulfone, polyphenylethersulfone, and polyvinylidenefluoride,
organic-inorganic silica polymers, including organically modified silicates, and silsesquioxanes,
inorganic oxide materials, including SiO₂, Al₂O₃, SiₓAl_{y}O_{z}, ZrO₂, TiO₂, ZnO, and SnO₂,
inorganic polysilazanes, including perhydropolysilazane, silazane co-polymers,
ceramic materials, including crystalline oxide, nitride or carbide ceramics, and
composite materials, including mixtures of ceramics, oxides, graphene, carbon nanotubes with one of the binder materials.

10. The light emitting element of claim 9, wherein the thermal conductivity of the NC thin layer or film is in the range from about 1 W/K·m to more than 30 W/K·m,
wherein high thermal conductivity materials are mechanically admixed to the QD/binder system, and/or
wherein the high-thermal conductivity materials preferably comprise at least one of:
inorganic oxide materials, including SiO₂, Al₂O₃, SiₓAl_{y}O_{z}, ZrO₂, TiO₂, ZnO, and SnO₂,
ceramic materials, including crystalline oxide, nitride or carbide ceramics, including Al₄N₃, Si₄N₃, SiC, and BN, and
carbon-based materials, including carbon black, graphene, carbon nanotubes.

11. The light emitting element of claim 1, further comprising a substrate material having a reflective surface.

12. A light source apparatus, comprising:
a light source, and
at least one light emitting element according to claim 1, or a plurality of light emitting elements according to claim 1.

13. A projector device, comprising:
a light source apparatus according to claim 12,
a light modulation element, and
a projection optical system.

14. A method of obtaining emissive semiconductor nano(crystal) (NC) materials encapsulated in a shell, comprising:
providing the NC materials,
providing chemical precursors for the synthesis of the encapsulating shell,
providing pre-formed emulsion droplets serving as reaction containers,
incorporating the shell precursors into the pre-formed emulsion droplets,
incorporating the NC into the pre-formed emulsion droplets,
carrying out a sol-gel chemical reaction in solution to form the shell using a reverse micro-emulsion procedure, and
providing a procedure to purify and isolate the shell-encapsulated NC material,
wherein the NC comprise elements of several groups of the periodic system, as defined in claim 3, and
wherein the shell material is a non-emissive material.

15. A method of obtaining emissive semiconductor nano(crystal) (NC) materials encapsulated in a monolith, comprising:
providing NC materials,
providing chemical precursors for the synthesis of the monolith,
carrying out a chemical reaction to form the monolith encapsulation of NC,
isolating the monolith encapsulated NC material,
wherein the NC comprise elements of several groups of the periodic system, as defined in claim 3, and
wherein the monolith material is a non-emissive material.

16. The method of claim 14, comprising the use of support ligands during the encapsulation, wherein
the support ligands are directly ad-mixed to the encapsulation reaction mixture during the encapsulation process and allowed to react with the NC nanocrystals before the shell or monolith formation; or
the support ligands are separately reacted with the initial NC material prior to the encapsulation, such that a protective ligand shell on the NC is formed which is not exchanged during the encapsulation process, including during the shell or monolith formation,
and
wherein the support ligands comprise organic ligands.

17. A method of generating a thin layer or film comprising semiconductor nano(crystal) (NC) materials, and a binder material, which are deposited on a substrate, said method comprising:
mixing the NC material with the binder material,
depositing the mixture on the substrate by at least one of spin coating, drop casting, doctor blading, and screen printing, and
curing of the deposited NC material/binder mixture,
wherein binder curing conditions for film preparation are between complete inert (0% oxygen, 0% relative humidity) to ambient (21% oxygen, up to 100% relative humidity); and/or temperature of binder curing is between ambient (22° C.) and 180° C.; and/or UV exposure for binder curing is between 1 J/cm2 and 16 kJ/cm² between 10 J/cm² and 10 J/cm²,
wherein the binder materials are as defined in claim 9.

18. A method of increasing the thermal conductivity of the light emitting element, comprising:
mechanical ad-mixing of high thermal conductivity materials to the NC/binder layer, preferably as obtained with the method of claim 17,
or
co-incorporation of high-thermal conductivity materials and NC into the shell or monolith encapsulation matrix,
wherein the high-thermal conductivity materials comprise at least one of:
inorganic oxide materials, such as SiO₂, Al₂O₃, SiₓAl_{y}O_{z}, ZrO₂, TiO₂, ZnO, and SnO₂,
ceramic materials, such as crystalline oxide, nitride or carbide ceramics, including Al₄N₃, Si₄N₃, SiC, and BN, and
carbon-based materials, including carbon black, graphene, and carbon nanotubes.
